(19) United States
(12) Patent Application Publication
(10) Pub. No.: US 2024/0228733 A9
(43) Pub. Date: Jul. 11, 2024

(54) SYSTEM, METHOD, AND APPARATUS FOR RECYCLING ASPHALT SHINGLES

(71) Applicant: Atlas James Russell, Albemarle, NC (US)

(72) Inventor: Atlas James Russell, Albemarle, NC (US)

(21) Appl. No.: 18/486,844

(22) Filed: Oct. 13, 2023

Related U.S. Application Data
(60) Provisional application No. 63/417,419, filed on Oct. 19, 2022.

(51) Int. Cl. C08J 11/12; B09B 3/38

(52) U.S. Cl. CPC C08J 11/12; B09B 3/38; C08J 2395/00

(57) ABSTRACT

A method for recycling asphalt shingles is provided, where the method includes heating an asphalt shingle input from a first source in a mixing unit to melt the asphalt shingle input and produce a molten asphalt, directing the molten asphalt into a separation unit, separating the molten asphalt, at the separation unit, into solid materials and a fluid asphalt, and receiving and storing the fluid asphalt in a storage tank. A separation unit and a system for recycling asphalt shingles is also disclosed.

### CROSS-REFERENCE TO RELATED APPLICATIONS

This application claims priority from U.S. provisional Application No. 63/417,419, filed on Oct. 19, 2022, which application is hereby incorporated in its entirety by reference in this application.

### FIELD OF THE DISCLOSURE

The present disclosure relates to recycling asphalt shingles. More particularly, the present disclosure relates to systems, methods, and apparatuses for recycling asphalt shingles.

### BACKGROUND

Certain embodiments of shingles are formed from asphalt. Asphalt shingles may be removed during the replacement of a roof. The removed asphalt shingles may be discarded. More preferably the asphalt shingles may be recycled. For example, the recycled asphalt shingles may be recycled to form asphalt pavement. However, certain existing embodiments of methods for recycling asphalt shingles may result in material waste (e.g., chunks of asphalt shingle and/or fluid asphalt) that cannot be used to produce recycled asphalt pavement and usually ends up in landfills. Accordingly, it would be desirable to recycle this material waste so as to avoid contributing to landfills.

### SUMMARY OF THE DISCLOSURE

Embodiments of the present disclosure relate to recycling asphalt shingles.

Example Embodiment 1: A method for recycling asphalt shingles, the method comprising: heating an asphalt shingle input from a first source in a mixing unit to melt the asphalt shingle input and produce a molten asphalt; directing the molten asphalt into a separation unit; separating the molten asphalt, at the separation unit, into solid materials and a fluid asphalt; and receiving and storing the fluid asphalt in a storage tank.

Example Embodiment 2: The method of Example Embodiment 1, or any combination of preceding example embodiments, further comprising directing a first quantity of the fluid asphalt from the separation unit into the storage tank and directing a second quantity of the fluid asphalt from the separation unit into the mixing unit or directing quantity of virgin fluid asphalt from a virgin fluid asphalt source into the mixing unit.

Example Embodiment 3: The method of Example Embodiment 2, or any combination of preceding example embodiments, further comprising mixing and heating the second quantity of the fluid asphalt with the asphalt shingle input in the mixing unit to produce the molten asphalt.

Example Embodiment 4: The method of Example Embodiment 1, or any combination of preceding example embodiments, further comprising grinding a plurality of asphalt shingles to produce the asphalt shingle input.

Example Embodiment 5: The method of Example Embodiment 1, or any combination of preceding example embodiments, further comprising agitating, by at least one circulation blade arranged in the mixing unit, the molten asphalt in the mixing unit.

Example Embodiment 6: The method of Example Embodiment 1, or any combination of preceding example embodiments, further comprising directing the solid materials into a transportable container arranged downstream of the separation unit.

Example Embodiment 7: The method of Example Embodiment 1, or any combination of preceding example embodiments, wherein the separation unit comprises an inverted conical shape having an internal diameter toward a top portion thereof larger than the internal diameter toward a bottom portion thereof, and wherein separating the molten asphalt into the solid materials and the fluid asphalt comprises allowing the solid materials to settle toward the bottom portion of the separation unit and the fluid asphalt to remain toward the top portion of the separation unit.

Example Embodiment 8: A separation unit, comprising: a tank defining an inverted conical shape having an internal diameter toward a top portion thereof that is larger than the internal diameter toward a bottom portion thereof; an inlet port connected to the tank and configured to receive a molten asphalt; a first outlet port connected toward the top portion of the tank and configured to output fluid asphalt separated from solid materials of the molten asphalt; a second outlet port connected at the bottom portion of the tank and configured to output the solid materials settled toward the bottom portion of the tank; and a heating mechanism configured to heat the molten asphalt in the tank.

Example Embodiment 9: The separation unit of Example Embodiment 8, or any combination of preceding example embodiments, further comprising a third outlet port connected to the tank between the first outlet port and the second outlet port, wherein the first outlet port is configured to output a first quantity of the fluid asphalt to a storage tank, and wherein a mixing unit is configured to receive a second quantity of the fluid asphalt output from the third outlet port or a quantity of virgin fluid asphalt output from a virgin fluid asphalt source.

Example Embodiment 10: The separation unit of Example Embodiment 8, or any combination of preceding example embodiments, further comprising a valve arranged at the second outlet port and configured to selectively direct the solid materials therethrough.

Example Embodiment 11: The separation unit of Example Embodiment 8, or any combination of preceding example embodiments, further comprising a pump positioned downstream of the first outlet port.

Example Embodiment 12: The separation unit of Example Embodiment 8, or any combination of preceding example embodiments, wherein the tank comprises an interior surface in contact with the molten asphalt and an exterior surface with a chamber defined therebetween, the heating mechanism comprising a quantity of heated oil circulating in the chamber of the tank to maintain a temperature of the molten asphalt in the tank between about 250 degrees Fahrenheit and about 350 degrees Fahrenheit.

Example Embodiment 13: A system for recycling asphalt shingles, the system comprising: a mixing unit arranged to receive an asphalt shingle input from a first source, the mixing unit configured to heat and melt the asphalt shingle input and produce a molten asphalt; a separation unit arranged to receive the molten asphalt and separate the molten asphalt into solid materials and a fluid asphalt; and a storage tank configured to receive and store the fluid asphalt output from the separation unit.

Example Embodiment 14: The system of Example Embodiment 13, or any combination of preceding example embodiments, further comprising a grinder configured to grind a plurality of asphalt shingles to produce the asphalt shingle input.

Example Embodiment 15: The system of Example Embodiment 13, or any combination of preceding example embodiments, further comprising at least one circulation blade arranged in the mixing unit to agitate the molten asphalt in the mixing unit.

Example Embodiment 16: The system of Example Embodiment 13, or any combination of preceding example embodiments, wherein the separation unit comprises: a tank defining an inverted conical shape having an internal diameter toward a top portion thereof that is larger than the internal diameter toward a bottom portion thereof, an inlet port connected to the tank and configured to receive a molten asphalt, a first outlet port connected toward the top portion of the tank and configured to output the fluid asphalt separated from the solid materials of the molten asphalt to the storage tank, a second outlet port connected at the bottom portion of the tank and configured to output the solid materials settled toward the bottom portion of the tank, and a heating mechanism configured to heat the molten asphalt in the tank.

Example Embodiment 17: The system of Example Embodiment 16, or any combination of preceding example embodiments, wherein the separation unit further comprises a third outlet port connected between the first outlet port and the second outlet port, wherein the first outlet port is configured to output a first quantity of the fluid asphalt to the storage tank, and wherein the mixing unit is configured to receive a second quantity of the fluid asphalt output from the third outlet port or a quantity of virgin fluid asphalt output from a virgin fluid asphalt source.

Example Embodiment 18: The system of Example Embodiment 17, or any combination of preceding example embodiments, wherein the mixing unit is configured to mix and heat the second quantity of the fluid asphalt with the asphalt shingle input to produce the molten asphalt.

Example Embodiment 19: The system of Example Embodiment 17, or any combination of preceding example embodiments, further comprising a transportable container arranged proximate the second outlet port of the separation unit and configured to collect the solid materials settled toward the bottom portion of the tank.

Example Embodiment 20: The system of Example Embodiment 17, or any combination of preceding example embodiments, wherein the tank of the separation unit comprises an interior surface in contact with the molten asphalt and an exterior surface with a chamber defined therebetween, the heating mechanism comprising a quantity of heated oil circulating in the chamber of the tank to maintain a temperature of the molten asphalt in the tank between about 250 degrees Fahrenheit and about 350 degrees Fahrenheit.

These and other features, aspects, and advantages of the disclosure will be apparent from a reading of the following detailed description together with the accompanying drawings, which are briefly described below.

### BRIEF DESCRIPTION OF THE DRAWINGS

In order to assist the understanding of embodiments of the disclosure, reference will now be made to the appended drawings, which are not necessarily drawn to scale. The drawings are exemplary only, and should not be construed as limiting the disclosure.

FIG. 1 schematically illustrates a system for recycling asphalt shingles according to a first example embodiment of the present disclosure;

FIG. 2 schematically illustrates a system for recycling asphalt shingles according to a second example embodiment of the present disclosure;

FIG. 3 schematically illustrates a controller of system for recycling asphalt shingles according to some example embodiments of the present disclosure; and

FIG. 4 schematically illustrates a method for recycling asphalt shingles according to some example embodiments of the present disclosure.

### DETAILED DESCRIPTION OF THE PREFERRED EMBODIMENTS

The present disclosure now will be described more fully hereinafter with reference to the accompanying drawings. The disclosure may be embodied in many different forms and should not be construed as limited to the embodiments set forth herein; rather, these embodiments are provided so that this disclosure will satisfy applicable legal requirements. Like numbers refer to like elements throughout. As used in this specification and the claims, the singular forms “a,” “an,” and “the” include plural references unless the context clearly dictates otherwise.

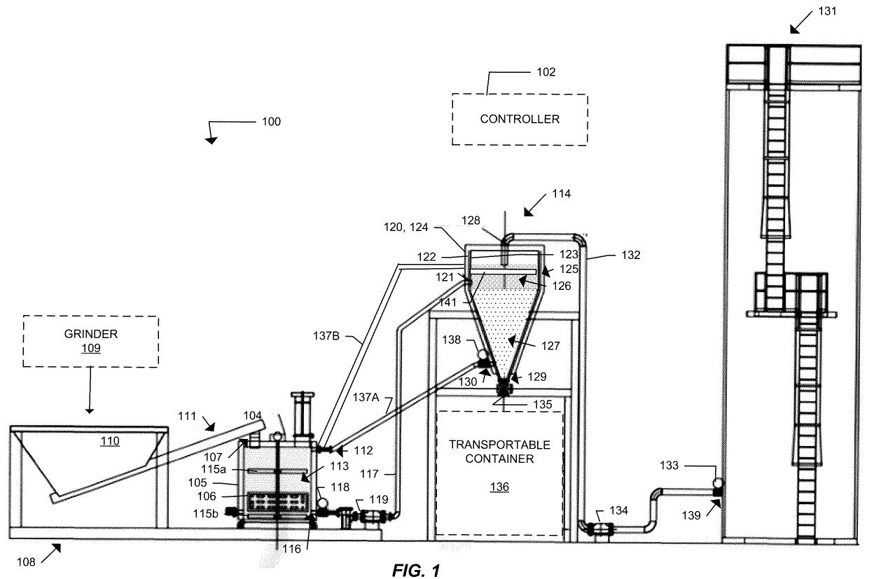

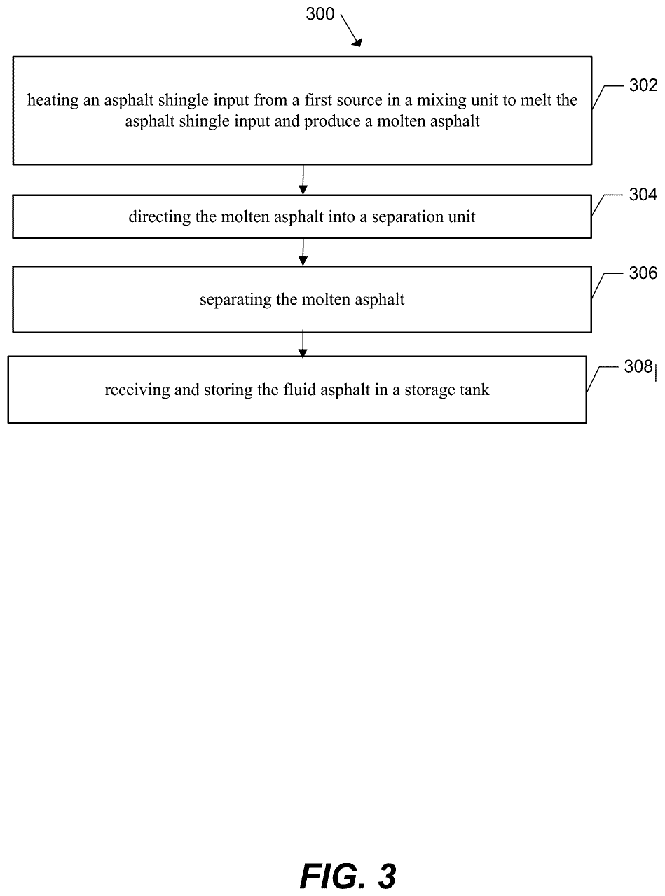

As described herein, embodiments of the disclosure relate to separating out fluid asphalt and solid materials (e.g., sand, crushed aggregate, or grit) from recycled asphalt shingles for secondary uses such as, for example, the sand, crushed aggregate, or grit can be used for asphalt purposes such as for roadway applications. In this regard, FIG. 1 illustrates a first embodiment of a system 100 for recycling asphalt shingles to produce the fluid asphalt and solid materials. The system 100 may be controlled by a controller 102 configured to control some or all of the operations described below. In some embodiments the controller 102 may comprise a programmable logic controller. Note that although the controller 102 is illustrated as a single, unitary device, in some embodiments the controller may be distributed across multiple separate devices that may separately or jointly control operation of various portions of the system 100. One example embodiment of the controller is described in greater detail in FIG. 3.

As illustrated in FIG. 1, the system 100 may further include one or more mixing units. For example, the system 100 may include a preliminary mixing unit and a primary mixing unit that perform different functions within the system. However, and as illustrated in FIG. 1, the system 100 comprises a single mixing unit 104 (e.g. a drum mixer), though more than one mixing unit may be utilized as contemplated within this disclosure.

The mixing unit 104 may comprise a tank 105 configured to mix and/or heat one or more inputs (e.g., one input, two inputs, three inputs, four inputs, five inputs, etc.). In some embodiments the mixing unit 104 may be employed in traditional asphalt mix production by combining a fluid asphalt input with a particulate input. Note that although use of a single input is described below, a greater number of inputs of the same or differing types may be employed in other embodiments. The mixing unit 104 may further comprise one or more load cells (not shown). The load cells may be employed to determine the individual masses of the one or more input(s) directed into the mixing unit 104. Thereby, a proper mixture thereof may be achieved. In addition, the mixing unit 104 may be configured to heat the input(s). For example, the mixing unit 104 may include a heater 106, e.g., an electric coil, a burner, a boiler, circulating hot fluid (e.g., oil or steam) surrounding the tank 105, and which heats and/or dries the various input(s) directed into the mixing unit 104. In this regard, the mixing unit 104 ideally minimizes the water content of the contents therein to the greatest extent possible.

The mixing unit 104 may be configured to receive an asphalt shingle input 107 from a first source 108. The asphalt shingle input 107 may be provided as a plurality solids, rather than in a liquid form. The asphalt shingle input 107 may comprise used asphalt shingles or scraps or rejects from asphalt shingle production, or any other embodiment of asphalt shingles. The asphalt shingles and scraps may be ground in a grinder 109 or otherwise processed to produce pieces of asphalt shingles defining a relatively smaller size, which are employed as the asphalt shingle input 107. Further, nails and other debris may be removed from the asphalt shingles during processing to produce the asphalt shingle input 107.

In some example embodiments, the grinder 109 may perform a crushing or grinding process on asphalt shingles as needed based on production and availability to a desired particle size (e.g., to maximum dimensions from about ⅛″ to about 1″, and preferably to maximum dimensions from about ¼″ to about ⅜″), cleaned of nails and other debris, and stockpiled to meet agency specifications. The processed asphalt shingle input 107 is generally stored in a stockpile at the mix plant site, on a well-drained area and/or covered to minimize the moisture content. The stockpile of the asphalt shingle input 107 may be tested prior to use in mix production for residual asphalt content, aggregate gradation, and moisture content. The asphalt shingle input 107 may be fed by a loader or other piece of equipment to a feed system, i.e., the first source 108. The feed system (and any of the other apparatuses described herein) may be interlocked with other plant components and controlled by the controller 102. The feed system 108 may include a feed hopper 110, which may be equipped with a variable frequency drive (VFD) motor, a strainer (e.g., comprising one or more screens), and one or more conveyors 111 (e.g., comprising an auger). The feed system may be calibrated to regulate flow of the asphalt shingle input 107 to the mixing unit 104, as controlled by the controller 102, and may account for moisture content, residual asphalt content, mixture production rates, and the percentage of the total asphalt mixture to be defined by the asphalt shingle input.

Other inputs of various varieties may also be mixed with the asphalt shingle input 107 in the mixing unit 104. For example, the mixing unit 104 may be configured to receive a fluid asphalt input. The fluid asphalt input may be either a recycled fluid asphalt input (i.e., a second quantity of fluid asphalt input 112) or a virgin fluid asphalt input from a virgin fluid asphalt source (not shown) directed into the mixing unit 104. The fluid asphalt input, also referred to as bitumen, is a black and highly viscous fluid form of petroleum. Optionally, and in some example embodiments, the mixing unit 104 is configured to receive a particulate input (not shown) from a source of particulate (not shown). The particulate input may include a degree of moisture (e.g., due to being stored outdoors), which may be lessened by the heater 106. The particulate input may comprise sand, gravel, crushed stone, slag, recycled concrete, aggregates (geosynthetic aggregates), and/or any other particulate materials. Use of recycled materials in the production of asphalt may be desirable in some embodiments. In this regard, certain asphalt-containing materials may be recycled in the system 100. Thus, for example, in some embodiments a recycled asphalt input (not shown) may be directed into the mixing unit 104. The recycled asphalt input may comprise recycled asphalt pavement.

When the asphalt shingle input 107 is received in the mixing unit 104, the heater 106 of the mixing unit 104 may heat the asphalt shingle input 107 and may entirely or substantially entirely melt the asphalt shingle input 107 to produce a molten asphalt 113 that is then directed to a separation unit 114. The temperature in the mixing unit 104 may be regulated (e.g., by the heater 106 as managed by the controller 102) to maintain a desired temperature generally between 250-450 degrees Fahrenheit depending on the type and grade of the asphalt shingle input 107 being used. For example, the tank 105 of the mixing unit 104 may be heated such that the molten asphalt 113 is heated to a temperature of between about 250 degrees Fahrenheit and about 350 degrees Fahrenheit, and desirably 400 degrees Fahrenheit, by the heater 106 so as to retain the molten asphalt 113 in fluid form during transport and introduction into the separation unit 114 such that issues with respect to the asphalt from the shingles resolidifying may be avoided.

As the asphalt shingle input 107 melts within the tank 105 of the mixing unit 104 to form the molten asphalt 113, it is continuously agitated by at least one circulation blade arranged in the mixing unit 104, to thereby remove moisture from the asphalt shingle input 107, activate the residual asphalt, and prevent precipitation of solids after the asphalt shingle input 107 is melted. In this manner, and as shown in FIG. 1, a first circulation blade 115a and a second circulation blade 115b may be arranged in the mixing unit 104. The first circulation blade 115a may be arranged vertically above the second circulation blade 115b in the tank 105, which may be arranged toward a bottom of the tank 105 of the mixing unit 104. Other types of mixers may also be utilized separately or in conjunction with the at least one circulation blade in the mixing unit 104.

In some example embodiments, the mixing unit 104 comprises an outlet port 116 arranged toward the bottom of the tank 105 of the mixing unit 104 and adjacent to the second circulation blade 115b. The molten asphalt 113 may be directed through the outlet port 116 to the separation unit 114. One or more heated injection lines 117 (e.g., one or more conduits) and/or valves 118 may be arranged downstream of the outlet port 116. An asphalt pump 119, which may be equipped with a VFD motor, may be controlled and interlocked to other plant components by means of the controller 102. For example, the asphalt pump 119 may be arranged in line with the heated injection line 117. The pump 119 may be configured to supply the molten asphalt 113 to the separation unit 114. The molten asphalt 113 may be metered to the separation unit 114 by the pump 119, as controlled by the controller 102 and metered by a flow meter (not shown), and regulated based on one or more factors such as, for example, capacity of the separation unit 114, production rates, etc.

The separation unit 114 may comprise a tank 120 defining an inverted conical shape having an internal diameter toward a top portion thereof that is larger than the internal diameter toward a bottom portion thereof. The separation unit 114 may comprise an inlet port 121 connected to the tank 120 and configured to receive the molten asphalt 113 from the mixing unit 104 through the heated injection line 117. The separation unit 114 may further comprise a heating mechanism 122 configured to heat the molten asphalt 113 in the tank 120.

When the molten asphalt 113 is received in the separation unit 114, it may be desirable to keep the molten asphalt heated to a specific temperature via the heating mechanism 122. In some example embodiments, the heating mechanism 122 is similar to the heater 106 of the mixing unit 104. In other example embodiments, however, the heating mechanism 122 of the separation unit 114 differs from the heater 106 of the mixing unit 104. For example, the tank 120 of the separation unit 104 may comprise an interior surface 123 that is in contact with the molten asphalt 113 and an exterior surface 124. A chamber 125 may be defined between the interior surface 123 and the exterior surface 124. A quantity of heated oil may continuously circulate in the chamber 125 of the tank 120 to maintain a temperature of the molten asphalt 113 in the tank 120 between about 250 degrees Fahrenheit and about 350 degrees Fahrenheit. Insulation may further be provided on the exterior surface 124 and/or the interior surface 123 to further insulate and maintain the desired temperature of the molten asphalt 113.

The separation unit 114 may comprise one or more mechanisms to separate the molten asphalt 113 into its constituent components; namely, fluid asphalt 126 and solid materials 127. In this manner, the separation unit 114 may comprise one or more filters, one or more centrifugal pumps, and the like. Alternatively, or in addition, the mechanism may be a more passive separation mechanism. For example, the tank 120 may be oriented such that a central axis of the tank 114 is vertically oriented, and so that the inverted conical shape of the tank 120 allows gravity to separate the molten asphalt 113 into fluid asphalt 126 which rise toward the top portion of the tank 120 and solid materials 127, which settle toward the bottom portion of the tank 120. Any other type of separation mechanism is also contemplated herein.

The separation unit 114 may further comprise a first outlet port 128 connected toward the top portion of the tank 120 and configured to output the fluid asphalt 126 separated from the solid materials 127 of the molten asphalt 113, and a second outlet port 129 connected at the bottom portion of the tank 120 and configured to output the solid materials 127 settled toward the bottom portion of the tank 120. In some example embodiments, the separation unit 114 comprises a third outlet port 130 connected to the tank 120. The third outlet port 130 may be connected above or below the inlet port 121 (i.e., at some location between the first outlet port 128 and the second outlet port 129), wherein the first outlet port 128 is configured to output a first quantity of the fluid asphalt to a storage tank 131 and the third outlet port 130 is configured to output a second quantity of the fluid asphalt (i.e., fluid asphalt input 112) to the mixing unit 104.

Regarding the first outlet port 128 of the separation unit 114, the first quantity of the fluid asphalt remaining toward the top portion of the tank 120 may be directed through the first outlet port 128 to the storage tank 131. One or more heated injection lines 132 (e.g., one or more conduits) and/or valves 133 may be arranged downstream of the first outlet port 128. A pump 134, which may be equipped with a VFD motor, may be controlled and interlocked to other plant components by means of the controller 102. For example, the pump 134 may be arranged downstream of the first outlet port 128 and in line with the heated injection line 132. The pump 134 may be configured to siphon the first quantity of the fluid asphalt from the top portion of the separation tank 114 and direct it to the storage tank 131. The first quantity of the fluid asphalt may be metered to the storage tank 131 by the pump 134, as controlled by the controller 102 and metered by a flow meter (not shown), and regulated based on one or more factors such as, for example, capacity of the storage tank 131, production rates, etc.

Turning to the second outlet port 129 of the separation unit 114, the second outlet port 129 may define an eight (8) to ten (10) inch opening through which the solid materials 127 exit after settling toward the bottom portion of the tank 120. One or more valves 135 may be arranged downstream of or at the second outlet port 129 to selectively direct/control (via the controller 102, for example) output of the solid materials 127 therethrough and into a transportable container 136 arranged downstream of the separation unit 114. The transportable container 136 may comprise a trailer or truck bed that can transport the solid materials 127 to a desired location. The solid materials 127 may comprise sand, crushed aggregate, grit, and the like, with particle sizes at no more than ⅛^{th} inch. The solid materials 127 may consist of mostly solid particulates, though some nominal quantity of fluid asphalt may be present in the solid materials 127. In this manner, the solid materials 127 may be metered to the transportable container 136 via the valve(s) 135, and regulated based on one or more factors such as, for example, capacity of the transportable container 136, production rates, etc.

Further, and regarding the third outlet port 130 of the separation unit 114, the second quantity of the fluid asphalt may be directed through the third outlet port 130 back to the mixing unit 104. One or more heated injection lines 137A, 137B (e.g., one or more conduits) and/or valves 138 may be arranged downstream of the third outlet port 130. For example, where the third outlet port 130 is located above the first inlet port 121, the heated injection line 137B is arranged downstream of the third outlet port 130. In another example, where the third outlet port 130 is located below the first inlet port 121, the heated injection line 137A is arranged downstream of the third outlet port 130. A pump (not shown), which may be equipped with a VFD motor, may be controlled and interlocked to other plant components by means of the controller 102. For example, the pump may be arranged downstream of the third outlet port 130 and in line with the heated injection line 137A or 137B. The pump may be configured to siphon any fluid asphalt trapped in the solid materials from the bottom portion of the separation tank 114 and direct it to the mixing unit 104 such that the second quantity of the fluid asphalt defines the fluid asphalt input 112 in the mixing unit 104. As such, the second quantity of the fluid asphalt may be metered to the mixing unit 104 by the pump, as controlled by the controller 102 and metered by a flow meter (not shown), and regulated based on one or more factors such as, for example, moisture content, residual asphalt content, mixture production rates, and the percentage of the total asphalt mixture to be defined by the asphalt shingle input 107 in the mixing unit 104. In this manner, the mixing unit 104 may mix and heat the fluid asphalt input 112 (i.e., the second quantity of the fluid asphalt) with the asphalt shingle input 107 to produce the molten asphalt 113.

As the molten asphalt 113 from the mixing unit 104 is directed to the separation tank 114, it is continuously agitated by at least one circulation blade 141 arranged in the separation tank 114. The circulation blade 141 may be arranged toward a top of the separation tank 11. Other types of mixers may also be utilized separately or in conjunction with the at least one circulation blade 141.

Turning now to the storage tank 131, the storage tank 131 may be configured to receive and store the fluid asphalt (i.e., the first quantity of the fluid asphalt) 126 output from the separation unit 114. The storage tank 131 may comprise a large volume tank, for example, a 30,000 gallon tank, that may store the fluid asphalt 126 at a desired temperature (e.g., about 400 to about 350 degrees Fahrenheit) until it is siphoned off and transported for secondary uses. In some example embodiments, the storage tank 131 comprises an inlet port 139 in communication with the heated injection lines 132. The valve 133 may be positioned upstream of the inlet port 139 and may be configured to filter out large particulates (e.g., stones) and/or solid materials. Further, the storage tank 131 may be covered (e.g., by a lid) so as to prevent water entry therein.

Notably, each of the conduits and other components handling fluid substances described herein may be heated. For example, a heated fluid (e.g., oil or steam) may be circulated amongst the components to maintain the fluidity of the asphalt materials (e.g., the molten asphalt 113, the fluid asphalt 126). By way of example, each of the conduits transporting the fluid asphalt materials may include an outer conduit that surrounds an inner conduit. The inner conduit may transport the asphalt materials (e.g., the molten asphalt 113), and the outer conduit may transport the heated fluid (e.g., oil or steam) so as to heat the asphalt materials received in the inner conduit to maintain the fluidity thereof.

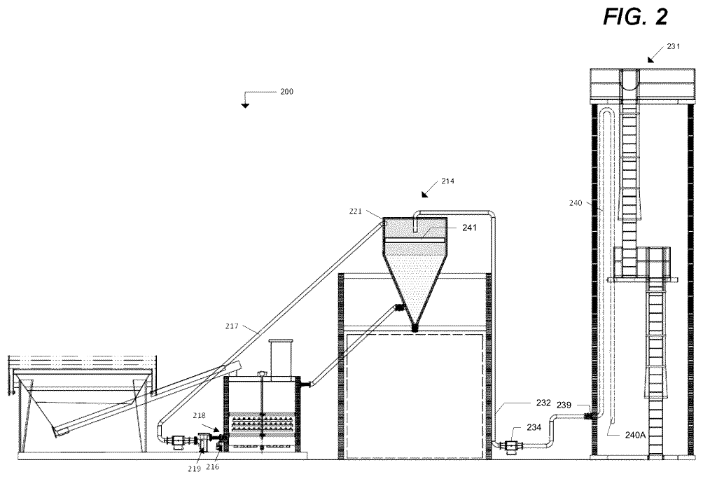

FIG. 2 illustrates a second example embodiment of a system 200 for recycling asphalt shingles to produce the fluid asphalt and solid materials. FIG. 2 may be substantially similar to the system 100 described in FIG. 1, such that the only reference numerals shown in FIG. 2 are those that are relevant to the elements that differ between the first and second embodiments. For example, FIG. 2 differs from FIG. 1 in that conduit 137B is not included, and conduit 117 (referred to as 217 in FIG. 2) is connected to the separation unit 114 (referred to as 214 in FIG. 2) at a different location. Additionally, a new conduit is illustrated in relation to storage tank 231.

In particular, heated injection line 217 (e.g., one or more conduits) and/or valves 218 may be arranged downstream of an outlet port 216 of the mixing unit 104. An asphalt pump 219, which may be equipped with a VFD motor, for example, may be controlled and interlocked to other plant components by means of the controller 102. For example, the asphalt pump 219 may be arranged in line with the heated injection line 217. The pump 219 may be configured to supply the molten asphalt 113 to the separation unit 214. The molten asphalt 113 may be metered to the separation unit 214 by the pump 219, as controlled by the controller 102 and metered by a flow meter (not shown), and regulated based on one or more factors such as, for example, capacity of the separation unit 214, production rates, etc.

The separation unit 214 may comprise a tank 120 defining an inverted conical shape having an internal diameter toward a top portion thereof that is larger than the internal diameter toward a bottom portion thereof. The separation unit 214 may comprise an inlet port 221 connected to the tank 120 and configured to receive the molten asphalt 113 from the mixing unit 104 through the heated injection line 217. The separation unit 214 may further comprise a heating mechanism 122 configured to heat the molten asphalt 113 in the tank 120. The inlet port 221 may be arranged above or below a circulation blade 241 arranged in the separation unit 214. As shown in FIG. 2, the inlet port 221 is arranged above the circulation blade 241.

Conduit 240 is illustrated in FIG. 2 in relation to the storage tank 231. The conduit 240 may be arranged within the storage tank 231 and be in fluid communication with heated injection line 232. The conduit 240 may be a heated line that may receive the fluid asphalt 126 from the separation unit 214 and direct it toward the bottom of the storage tank 231. In this manner, the conduit 240 interfaces with the heated injection line 232 at inlet port 239. In some example embodiments, and as shown in FIG. 2, the conduit 240 is U-shaped. In this example, a first vertical portion of the U-shaped conduit 240 may include an inlet portion that interfaces with the inlet port 239. The fluid asphalt 126 may be pumped through the inlet port 239, via pump 234 for example, and up the first vertical portion of the conduit 240. A bent portion of the U-shaped conduit 240 may be arranged at an end of the first vertical portion of the U-shaped conduit 240 and curve the U-shaped conduit 240 back down toward a bottom of the storage tank 231. A second vertical portion of the U-shaped conduit 240 may include an end that is arranged in fluid communication with the bent portion and may vertically extend down toward a bottom of the storage tank 231. An outlet portion 240A of the U-shaped conduit 240 may be where the fluid asphalt 126 is deposited into the storage tank 231. Other shapes, lengths, widths, etc., of the conduit 240 are also contemplated with this disclosure. Notably, one or more openings in the first and/or second vertical portions of the conduit 240 may be provided so that fluid asphalt 126 may easily exit the conduit as the storage tank 231 fills up with fluid asphalt.

A method for producing asphalt mix is also provided as illustrated in FIG. 3. The method, generally referred to as method 300 comprises. The method 300 comprises a first step 302 including heating an asphalt shingle input from a first source in a mixing unit to melt the asphalt shingle input and produce a molten asphalt, a second step 304 including directing the molten asphalt into a separation unit, a third step 306 including separating the molten asphalt, at the separation unit, into solid materials and a fluid asphalt, and a fourth step 308 including receiving and storing the fluid asphalt in a storage tank.

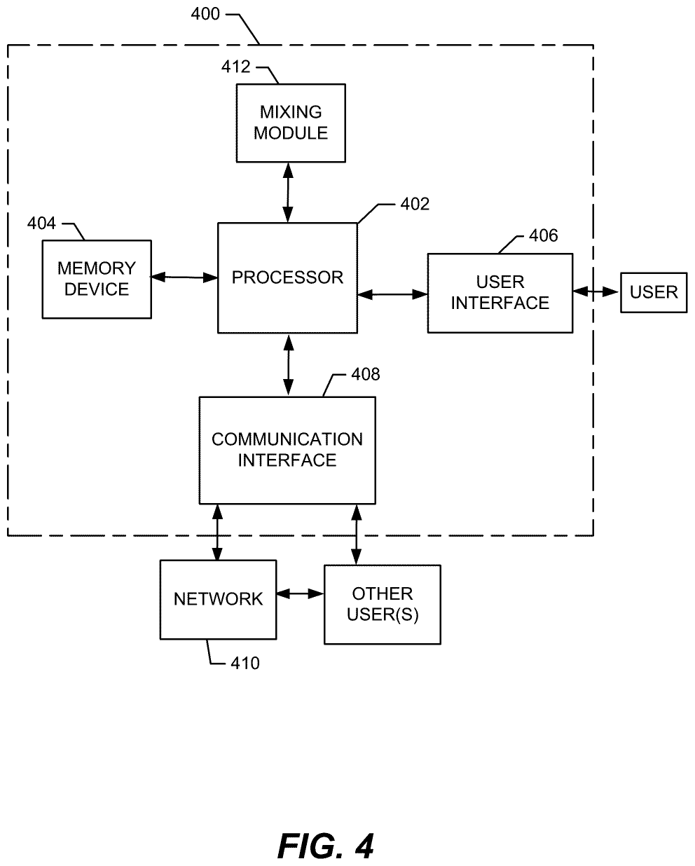

FIG. 4 schematically illustrates an embodiment of a controller, generally designated 400, such as the controller 102 illustrated and described in connection with FIGS. 1 and 2. The controller 400 may be configured to execute computer code for performing the operations described herein. In this regard, the controller 400 may comprise a processor 402 that may be a microprocessor or a controller for controlling the overall operation thereof. In one embodiment the processor 402 may be particularly configured to execute program code instructions related to the functions described herein, including the operations for forming the molten asphalt 113 from the asphalt shingle input 107, separating the molten asphalt 113, and transporting the fluid asphalt 126 to the storage tank 131. The controller 400 may also include a memory device 404. The memory device 404 may include non-transitory and tangible memory that may be, for example, volatile and/or non-volatile memory. The memory device 404 may be configured to store information, data, files, applications, instructions or the like. For example, the memory device 404 could be configured to buffer input data for processing by the processor 402. Additionally or alternatively, the memory device 404 may be configured to store instructions for execution by the processor 402.

The controller 400 may also include a user interface 406 that allows a user to interact therewith. For example, the user interface 406 can take a variety of forms, such as a button, keypad, dial, touch screen, audio input interface, visual/image capture input interface, input in the form of sensor data, etc. Still further, the user interface 406 may be configured to output information to the user through a display, speaker, or other output device. A communication interface 408 may provide for transmitting and receiving data through, for example, a wired or wireless network 410 such as a local area network (LAN), a metropolitan area network (MAN), and/or a wide area network (WAN), for example, the Internet. The communication interface 408 may enable the controller 400 to communicate with one or more further computing devices, either directly, or via the network 410. In this regard, the communication interface 408 may include one or more interface mechanisms for enabling communication with other devices and/or networks. The communication interface 408 may accordingly include one or more interface mechanisms, such as an antenna (or multiple antennas) and supporting hardware and/or software for enabling communications via wireless communication technology (e.g., a cellular technology, communication technology, Wi-Fi and/or other IEEE 802.11 technology, Bluetooth, Zigbee, wireless USB, NFC, RF-ID, WiMAX and/or other IEEE 802.16 technology, and/or other wireless communication technology) and/or a communication modem or other hardware/software for supporting communication via cable, digital subscriber line (DSL), USB, FireWire, Ethernet, one or more optical transmission technologies, and/or other wireline networking methods. Further, the controller 400 may include a mixing module 412. The mixing module 412 may be configured to, in conjunction with the processor 402, for example, direct operations for forming the molten asphalt 113 from the asphalt shingle input 107, separating the molten asphalt 113, etc., as described herein.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a computer readable medium for controlling the above-described operations. In particular, computer readable code may be configured to perform each of the operations of the methods described herein and embodied as computer readable code on a computer readable medium for controlling the above-described operations. In this regard, a computer readable storage medium, as used herein, refers to a non-transitory, physical storage medium (e.g., a volatile or non-volatile memory device, which can be read by a computer system. Examples of the computer readable medium include read-only memory, random-access memory, CD-ROMs, DVDs, magnetic tape, and optical data storage devices. The computer readable medium can also be distributed over network-coupled computer systems so that the computer readable code is stored and executed in a distributed fashion.

As noted above, the controller 400 may be configured to execute computer code for performing the above-described mixing operations. In this regard, an embodiment of a non-transitory computer readable medium for storing computer instructions executed by a processor in a controller (e.g. controller 400) configured to form the molten asphalt 113 from the asphalt shingle input 107 is provided. The non-transitory computer readable medium may thus include program code instructions for performing the operations disclosed herein.

Note that although the apparatuses, systems, and methods provided herein are generally described as being used in the recycling of asphalt shingles, such apparatuses, systems, and methods may be employed to recycle other asphalt-based products. For example, the apparatuses, systems, and methods of the present disclosure may be employed to produce asphalt shingles. In this regard, the apparatuses, systems, and methods of the present disclosure are configured to recycle any asphalt-based products into a form usable as an input for the production of any asphalt-based product.

Many modifications and other embodiments of the disclosure will come to mind to one skilled in the art to which this disclosure pertains having the benefit of the teachings presented in the foregoing description; and it will be apparent to those skilled in the art that variations and modifications of the present disclosure can be made without departing from the scope or spirit of the disclosure. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method for recycling asphalt shingles, the method comprising:
heating an asphalt shingle input from a first source in a mixing unit to melt the asphalt shingle input and produce a molten asphalt;
directing the molten asphalt into a separation unit;
separating the molten asphalt, at the separation unit, into solid materials and a fluid asphalt; and
receiving and storing the fluid asphalt in a storage tank.

2. The method of claim 1, further comprising directing a first quantity of the fluid asphalt from the separation unit into the storage tank and directing a second quantity of the fluid asphalt from the separation unit into the mixing unit or directing quantity of virgin fluid asphalt from a virgin fluid asphalt source into the mixing unit.

3. The method of claim 2, further comprising mixing and heating the second quantity of the fluid asphalt with the asphalt shingle input in the mixing unit to produce the molten asphalt.

4. The method of claim 1, further comprising grinding a plurality of asphalt shingles to produce the asphalt shingle input.

5. The method of claim 1, further comprising agitating, by at least one circulation blade arranged in the mixing unit, the molten asphalt in the mixing unit.

6. The method of claim 1, further comprising directing the solid materials into a transportable container arranged downstream of the separation unit.

7. The method of claim 1, wherein the separation unit comprises an inverted conical shape having an internal diameter toward a top portion thereof larger than the internal diameter toward a bottom portion thereof, and wherein separating the molten asphalt into the solid materials and the fluid asphalt comprises allowing the solid materials to settle toward the bottom portion of the separation unit and the fluid asphalt to remain toward the top portion of the separation unit.

8. A separation unit, comprising:
a tank defining an inverted conical shape having an internal diameter toward a top portion thereof that is larger than the internal diameter toward a bottom portion thereof;
an inlet port connected to the tank and configured to receive a molten asphalt;
a first outlet port connected toward the top portion of the tank and configured to output fluid asphalt separated from solid materials of the molten asphalt;
a second outlet port connected at the bottom portion of the tank and configured to output the solid materials settled toward the bottom portion of the tank; and
a heating mechanism configured to heat the molten asphalt in the tank.

9. The separation unit of claim 8, further comprising a third outlet port connected to the tank between the first outlet port and the second outlet port, wherein the first outlet port is configured to output a first quantity of the fluid asphalt to a storage tank, and
wherein a mixing unit is configured to receive a second quantity of the fluid asphalt output from the third outlet port or a quantity of virgin fluid asphalt output from a virgin fluid asphalt source.

10. The separation unit of claim 8, further comprising a valve arranged at the second outlet port and configured to selectively direct the solid materials therethrough.

11. The separation unit of claim 8, further comprising a pump positioned downstream of the first outlet port.

12. The separation unit of claim 8, wherein the tank comprises an interior surface in contact with the molten asphalt and an exterior surface with a chamber defined therebetween, the heating mechanism comprising a quantity of heated oil circulating in the chamber of the tank to maintain a temperature of the molten asphalt in the tank between about 250 degrees Fahrenheit and about 350 degrees Fahrenheit.

13. A system for recycling asphalt shingles, the system comprising:
a mixing unit arranged to receive an asphalt shingle input from a first source, the mixing unit configured to heat and melt the asphalt shingle input and produce a molten asphalt;
a separation unit arranged to receive the molten asphalt and separate the molten asphalt into solid materials and a fluid asphalt; and
a storage tank configured to receive and store the fluid asphalt output from the separation unit.

14. The system of claim 13, further comprising a grinder configured to grind a plurality of asphalt shingles to produce the asphalt shingle input.

15. The system of claim 13, further comprising at least one circulation blade arranged in the mixing unit to agitate the molten asphalt in the mixing unit.

16. The system of claim 13, wherein the separation unit comprises:
a tank defining an inverted conical shape having an internal diameter toward a top portion thereof that is larger than the internal diameter toward a bottom portion thereof,
an inlet port connected to the tank and configured to receive a molten asphalt,
a first outlet port connected toward the top portion of the tank and configured to output the fluid asphalt separated from the solid materials of the molten asphalt to the storage tank,
a second outlet port connected at the bottom portion of the tank and configured to output the solid materials settled toward the bottom portion of the tank, and
a heating mechanism configured to heat the molten asphalt in the tank.

17. The system of claim 16, wherein the separation unit further comprises a third outlet port connected between the first outlet port and the second outlet port, wherein the first outlet port is configured to output a first quantity of the fluid asphalt to the storage tank, and
wherein the mixing unit is configured to receive a second quantity of the fluid asphalt output from the third outlet port or a quantity of virgin fluid asphalt output from a virgin fluid asphalt source.

18. The system of claim 17, wherein the mixing unit is configured to mix and heat the second quantity of the fluid asphalt with the asphalt shingle input to produce the molten asphalt.

19. The system of claim 17, further comprising a transportable container arranged proximate the second outlet port of the separation unit and configured to collect the solid materials settled toward the bottom portion of the tank.

20. The system of claim 17, wherein the tank of the separation unit comprises an interior surface in contact with the molten asphalt and an exterior surface with a chamber defined therebetween, the heating mechanism comprising a quantity of heated oil circulating in the chamber of the tank to maintain a temperature of the molten asphalt in the tank between about 250 degrees Fahrenheit and about 350 degrees Fahrenheit.
